(19) United States
(12) Patent Application Publication
(10) Pub. No.: US 2016/0351135 A1
(43) Pub. Date: Dec. 1, 2016

(54) THICK ROUTING LINES IN DARK TRENCHES

(71) Applicant: Pixtronix, Inc., San Diego, CA (US)

(72) Inventors: Matthew Brian Sampsell, San Jose, CA (US); Patrick Forrest Brinkley, San Mateo, CA (US); Isak Clark Reines, San Diego, CA (US); Teruo Sasagawa, Los Gatos, CA (US); Jasper Lodewyk Steyn, Campbell, CA (US)

(21) Appl. No.: 14/724,410

(22) Filed: May 28, 2015

(51) Int. Cl. G09G 3/34; G02B 26/04

(52) U.S. Cl. CPC G09G 3/3433; G02B 26/04

(57) ABSTRACT

Implementations described herein relate to display devices including a metal circuit layer embedded in a dielectric layer configured to provide optical properties. Trenches in the dielectric layer may be etched so that the thickness of the metal circuit layer may extend away from other circuit layers. In some implementations, the metal circuit layer can include thick metal routing lines to send data to pixels of the display device. The thick metal routing lines can provide high conductivity, minimal voltage drop, and signal speed that is sufficiently high to write data to many pixels over long distances. In some implementations, the dielectric layer can be configured to absorb light. Examples of such dielectric layers include carbon-doped spin-on-glass dielectric layers.

### TECHNICAL FIELD

This disclosure relates to display devices, and more particularly to incorporation of routing lines in display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Certain EMS devices are display devices. In operation of display device, a large amount of data may be written to pixels of the device. In a field sequential color display, for example, separate color subframes are displayed in sequence. For a shutter-based MEMS display, a shutter may be opened and closed multiple times for each color at different pulse lengths. Appropriate data is sent to each pixel many times per frame to actuate a shutter. Other types of displays, including liquid crystal displays (LCDs), organic light-emitting diode (OLED) displays, and EMS and MEMS-based displays may also write large amounts of data to the pixels.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus. The display apparatus may include a plurality of display elements; an optical dielectric layer; a first metal circuit layer capable of delivering electric signals to the display elements; and a second metal circuit layer, with the second metal circuit layer disposed between the plurality of display elements and the first metal circuit layer, and where the first metal circuit layer is embedded in the optical dielectric layer.

According to various implementations, the optical dielectric layer may be configured to absorb light, reflect light, or prevent transmission of light. The optical dielectric layer may be a single dielectric layer or stack of dielectric layers. In one example, an optical dielectric layer may include a stack of dielectric layers configured to reflect light on one side of the stack and prevent transmission of light toward either side of the stack. In some implementations, the optical dielectric layer may be a spin-on-glass (SOG) layer, for example, a carbon-doped SOG layer.

The display apparatus may further include a third metal circuit layer disposed between the first metal circuit layer and the second metal circuit layer. In some implementations, the display elements are MEMS display elements. The optical dielectric layer may include etched display apertures.

In some implementations, the first metal circuit layer is embedded into only a portion of the thickness of the optical dielectric layer. In some implementations, the first metal circuit layer extends throughout the entire thickness of the optical dielectric layer. The display apparatus may further include an optical stack on or under the first metal circuit layer. In some implementations, such an optical stack may be embedded in the optical dielectric layer. In some implementations, the first metal circuit layer includes metal routing lines having a thickness of least 0.2 microns.

In some implementations, the second metal circuit layer may be configured to directly interact with the display elements. The display apparatus may further include a second dielectric layer disposed between the first metal circuit layer and the second metal circuit layer. The second dielectric layer may be an optically transmissive layer, such as an optically transmissive SOG layer.

In some implementations, the display apparatus may further include a processor capable of communicating with the display elements, the processor being capable of processing image data; and a memory device capable of communicating with the processor. The display apparatus may further include a driver circuit capable of sending at least one signal to the display elements; and a controller capable of sending at least a portion of the image data to the driver circuit. In some implementations, the display apparatus may include an image source module capable of sending the image data to the processor, where the image source module includes at least one of a receiver, transceiver and transmitter.

Another innovative aspect of the subject matter described in this disclosure can be implemented in a display apparatus including a plurality of display elements; means for delivering electric signals to the display elements, wherein the means for delivering electric signals to the display elements include a first metal circuit layer; and means for electrically insulating the first metal circuit layer from a second metal circuit layer.

In some implementations, the means for electrically insulating the first metal circuit layer from the second metal circuit layer include means for absorbing light from the second metal circuit layer. In some implementations, the means for electrically insulating the first metal circuit layer from the second metal circuit layer include means for absorbing light from the first metal circuit layer.

Another innovative aspect of the subject matter described in this disclosure can be implemented a method of fabricating a display device. The method can include forming an optical dielectric layer over a substrate; etching a trench in the optical dielectric layer; filling the trench with metal to form a metal routing line; forming a second dielectric layer over the metal routing line; and forming a metal layer over the second dielectric layer. The metal routing line may have a thickness of having a thickness of at least 0.2 microns. According to various implementations, the optical dielectric layer may be configured to absorb or reflect light. In some implementations, the optical dielectric layer includes a stack of dielectric layers configured to reflect light on one side of the stack and prevent transmission of light toward either side of the stack. In some implementations, forming the optical dielectric layer includes a spin-coating process.

Details of one or more implementations of the subject matter described in this disclosure are set forth in the accompanying drawings and the description below. Other features, aspects and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIGS. 3A and 3B show cross-sectional views of examples of display apparatuses including a metal circuit layer embedded in an optical dielectric layer.

FIG. 4 shows a simplified cross-sectional view of an example of a metal circuit layer embedded in an optical dielectric layer.

FIGS. 5A-5F shows examples of metal routing lines embedded in optical dielectric layers.

FIG. 5G shows an example of metal routing lines embedded in an optical dielectric layer disposed under a thin film transistor (TFT) backplane.

FIGS. 6A-8D show simplified cross-sectional views of various stages of examples of fabricating display apparatuses including metal routing lines embedded in optical dielectric layers.

FIG. 9 is a flow diagram illustrating an example of operations of a method of fabricating a display apparatus including a metal circuit layer embedded in an optical dielectric layer.

FIGS. 10A and 10B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Implementations described herein relate to display devices including a metal circuit layer embedded in a dielectric layer that is configured to provide optical properties. Trenches in the dielectric layer may be etched so that the thickness of the metal circuit layer extends away from other circuit layers. In some implementations, the metal circuit layer can include thick metal routing lines to send data or other electric signals to pixels of the display device. The thick metal routing lines can provide high conductivity, minimal voltage drop, and signal speed that is sufficiently high to write data to many pixels over long distances. In some implementations, the dielectric layer can be configured to absorb light. Examples of such dielectric layers include carbon-doped spin-on-glass dielectric layers. In some implementations, the metal circuit layer may be disposed under a thin film transistor (TFT) backplane.

Particular implementations of the subject matter described in this disclosure can be implemented to realize one or more of the following potential advantages. Display device thickness may be reduced by embedding a metal circuit layer in a dielectric layer that is configured to provide optical properties to the display. Power, uniformity, and yield of a display device may be improved by reducing parasitic capacitance, signal induction, and cross-coupling between metal circuit layers in a display device. This also allows the use of thinner planarization layers for more robust fabrication.

A low resistance metal circuit layer may reduce RC delays for circuit routing, which can enable larger displays and higher bit rates. A metal circuit layer disposed under a TFT backplane can include routing layers that do not fit in a standard backplane and can facilitate higher resolution displays. Row and column lines may be routed in a display area rather than around the periphery of a display, allowing for a significant reduction in the size of the display bezel. Additional layout flexibility is achieved with a metal routing line that can be routed under a bottom gate of a TFT without negatively impacting the transistor performance, unlike metal layers that route on top of a bottom gate TFT device.

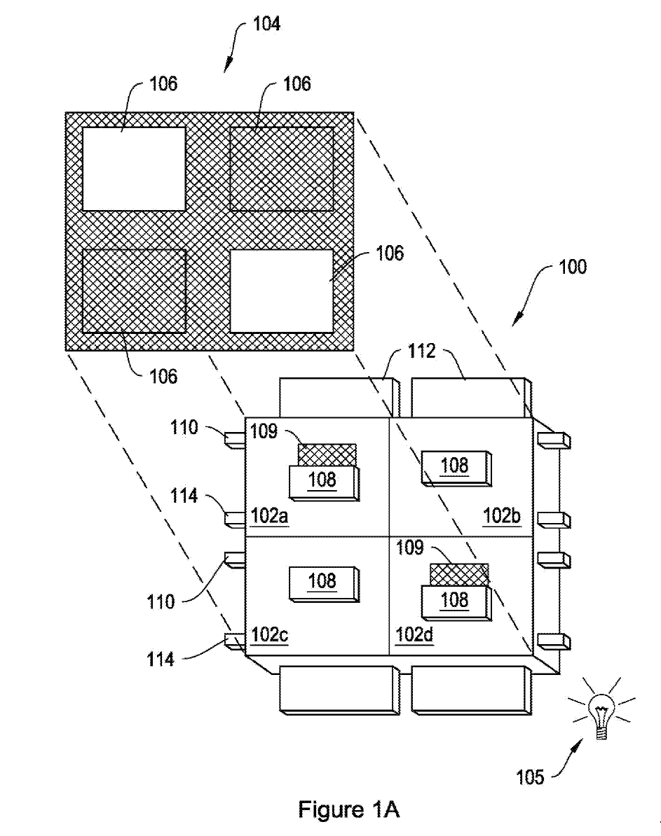

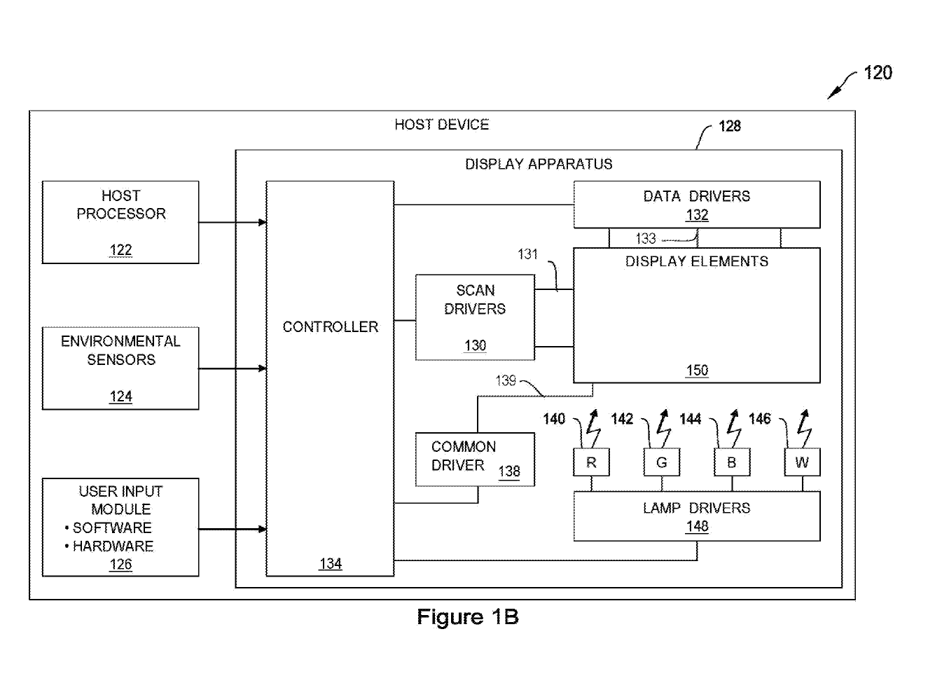

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

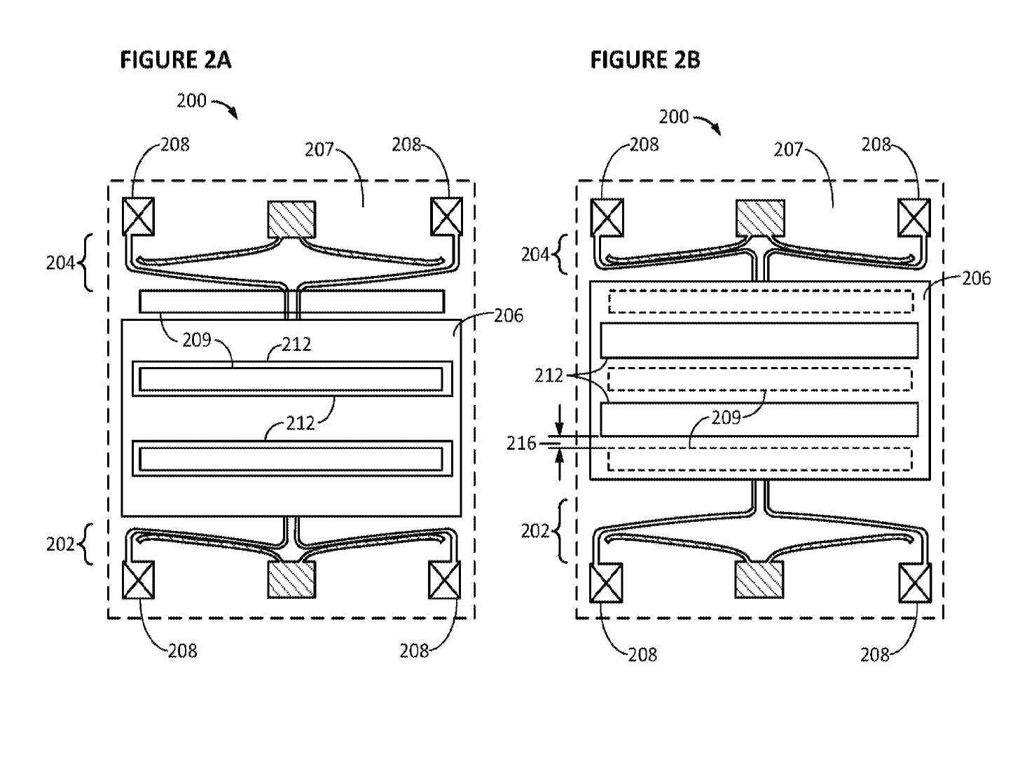

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

A display apparatus may include multiple layers of circuitry including signal routing lines, thin film transistors (TFTs), and electrodes that interact with the display elements. Such circuitry may take the form of multiple metal layers separated by dielectric layers. In the description below, these metal circuit layers may be referred to as M0, M1, M2, M3, etc., each of which denotes a layer of metallization. A metal circuit layer may include thick routing lines to write data or other electronic signals to the display elements. For example, as described above with respect to FIG. 1B, data may be loaded to the array of display elements 150 by a sequential addressing of individual rows. Thick routing lines, which may run the length of the display apparatus, have high conductivity, minimal voltage drop, and speed sufficiently high to write data to many display elements over long distances.

According to various implementations, display devices disclosed herein include a metal circuit layer that is embedded in a dielectric layer that is configured to provide optical properties. In certain implementations, the dielectric layer may be a light-absorbing dielectric layer or a light-reflecting dielectric layer. In a particular example, the dielectric layer may be a light-absorbing layer configured to block reflective metal circuitry and improve the ambient contrast of the display. In another example, the dielectric layer may be a multi-layer stack of dielectric films configured to reflect light on one side of the stack and prevent transmission of light toward either side of the stack.

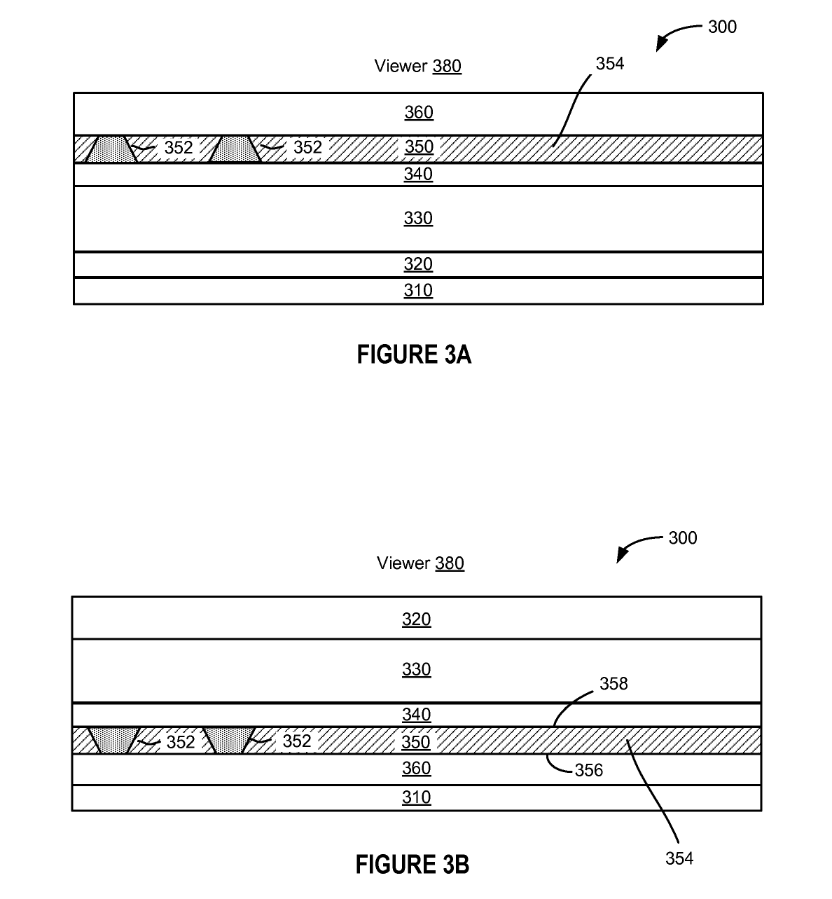

FIGS. 3A and 3B show cross-sectional views of examples of display apparatuses including a metal circuit layer embedded in an optical dielectric layer. It should be noted that the relative dimensions of the layers of the display apparatuses are not drawn to scale for the purposes of illustration. Further, in various implementations, a display apparatus may include more or fewer components than depicted in the examples of FIGS. 3A and 3B.

In FIG. 3A, a display apparatus 300 includes a backplane substrate 360, circuit layers 340 and 350, display elements 330, a substrate 320 and a backlight 310. In some implementations, the display elements 330 are MEMS-based display elements, such as the light modulators described in FIGS. 1A and 1B or the dual actuator shutter assemblies 200 described in FIGS. 2A and 2B. In some implementations, the display elements 330 may be LCD or OLED display elements.

The backlight 310 can, for example, include a light source coupled to a light guide through which light travels to a display panel. An optical filter may be placed over the light source to generate a desired optical effect, such as absorbing light having a certain wavelength or wavelength range and allowing passage of a certain wavelength or wavelength range. The backlight 310 can also have one or more optical components each with one or more optical surfaces designed to extract and distribute the light angularly and in space in order to produce desired uniformity and efficiency for the display apparatus 300. Light may pass through the substrate 320 to reach the display elements 330. In some implementations, the substrate 320 may be a substrate on which a reflective aperture layer as described above with respect to FIGS. 2A and 2B is formed. Such a substrate may be referred to as an aperture plate.

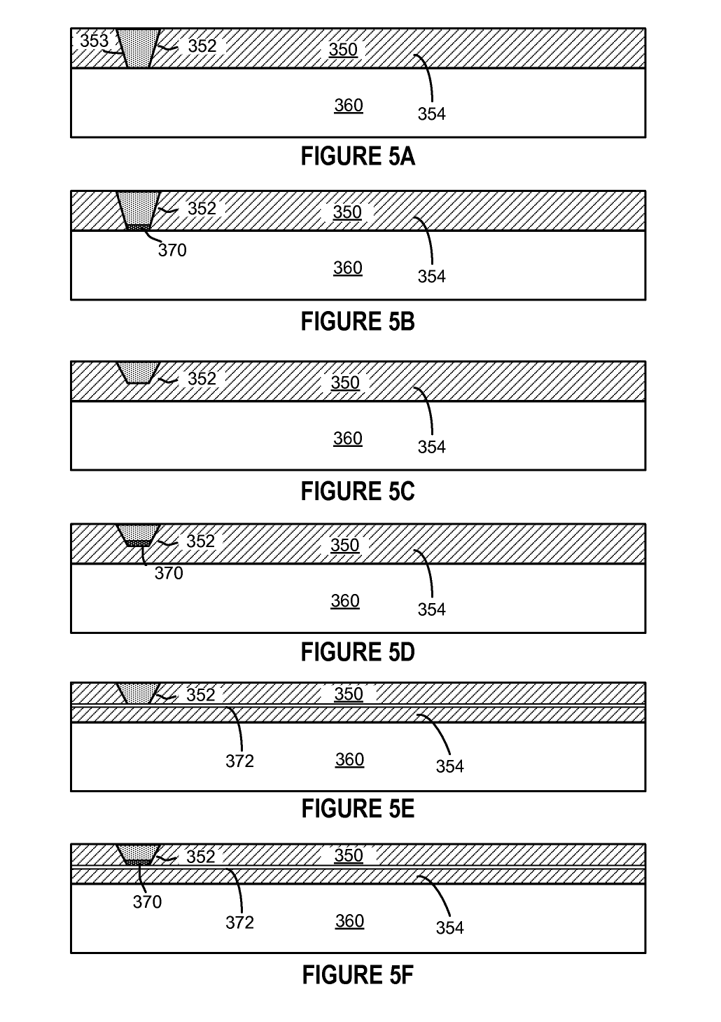

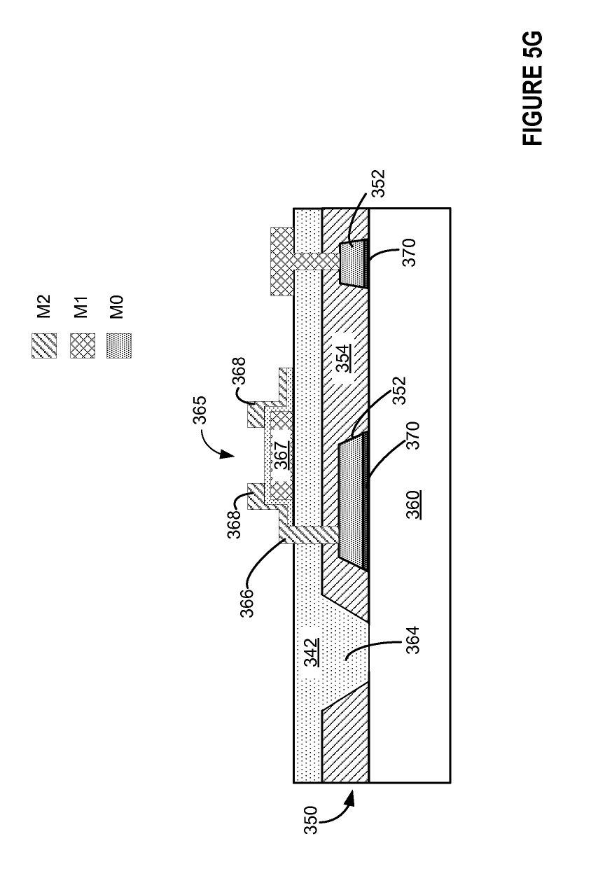

The circuit layer 350 includes metal routing lines 352 embedded in an optical dielectric layer 354. While two metal routing lines 352 are depicted in FIG. 3A for clarity, the circuit layer 350 may include any number of metal routing lines. According to various implementations, the metal routing lines 352 may extend for a relatively long distance, e.g., on order of the length of the display, and can be used to write data and/or apply voltages to the display elements 330. The metal routing lines 352 are embedded in the optical dielectric layer 354, with the term embedded referring to sidewalls of the metal routing lines 352 being at least partially surrounded by the optical dielectric layer 354. Further description and examples of embedded metal lines are described below with respect to FIGS. 5A-5G.

An optical dielectric refers to a dielectric that is configured to provide one or more optical properties to the display apparatus. According to various implementations, the optical dielectric may be configured to reflect or absorb light from one or more sides of the optical dielectric layer. In some implementations, the optical dielectric layer may be characterized as having a visible light transmittance of less than 20%, and in some cases of less than 7%. In some implementations, the optical dielectric layer may be characterized as having a visible light absorption of at least 80%, and some cases at least 92%. In some implementations, the optical dielectric layer may be characterized as having a visible light reflectivity of at least 85%, and in some cases at least 98%.

In the example of FIG. 3A, the optical dielectric layer 354 may be a dark dielectric configured to absorb light to prevent a viewer 380 from seeing the reflective metal lines of the circuit layers 340 and 350. As such, the optical dielectric layer 354 may improve the ambient contrast of the display apparatus 300. The optical dielectric layer 354 may have the additional benefit of protecting light sensitive circuit elements, such as some TFTs, from light exposure. In some implementations, the optical dielectric layer 354 is a dark carbon-doped spin-on-glass (SOG) material. The SOG material may be a carbon-doped silicate or siloxane with examples including carbon-doped hydrogen silsesquioxane (HSQ) and methylsilozane.

In the example of FIG. 3A, the embedded metal routing lines 352 of the circuit layer 350 make up the M0 layer, i.e., the metal layer furthest from the display elements 330. This can be useful in implementations in which the embedded metal routing lines 352 route driving signals to the display elements 330. However, in some other implementations, there may be one or more additional metal lines that are further from the display elements 330, e.g., disposed between the backplane substrate 360 and the circuit layer 350.

As discussed above, the metal routing lines 352 may be relatively thick to transmit driving signals over the length of the display at sufficiently high speeds. In some implementations, the metal routing lines are between about 0.2 and 1.0 microns, for example. In some other implementations, the metal routing lines are between about 0.3 and 0.8 microns. Appropriate metals for one-layer routing lines include highly conductive metals such as aluminum (Al), copper (Cu), and gold (Au). The metal routing layers may also include more than one layer of metal and may also include dielectrics between the metals. For example, the metal routing lines may include a layer of highly conductive metals such as Al, Cu, and Au and one or more layers of darker (i.e., less reflective) metal layers like molybdenum (Mo), tungsten (W), or titanium (Ti) above and/or below the highly conductive metal. There may also be dielectrics included in the routing stack to make the stack more or less reflective.

The circuit layer 340 includes one or more additional metal layers separated by dielectric layers. For example, the circuit layer 340 may include an M1 layer that includes TFT gate metallization, an M2 layer that includes TFT source/drain metallization, and an M3 layer that includes electrodes to interact with the display elements 330.

FIG. 3B shows another example of a display apparatus including a metal circuit layer embedded in an optical dielectric layer. In the example of FIG. 3B, circuit layers 340 and 350 on a backplane substrate 360 are disposed between a backlight 310 and display elements 330. A viewer 380 sees images through a substrate 320. In some implementations, the substrate 320 is an aperture plate for a shutter-based MEMS display as described above with reference to FIGS. 1A-2B.

As in FIG. 3A, the circuit layer 350 in the example of FIG. 3B includes metal routing lines 352 embedded in an optical dielectric layer 354. In the example of FIG. 3B, however, the optical dielectric layer 350 may be a multi-layer stack of dielectric layers configured to reflect light from the backlight 310 on a first side 356 of the multi-layer stack and prevent transmission of light toward either side of the multi-layer stack. The reflective first side 356 allows light rays from the backlight 310 that do not pass through the display elements 330 to be returned to the backlight 310. In this fashion the light can be recycled and made available for transmission, increasing the efficiency of the display. A multi-layer stack may include various oxides, nitrides and/or oxynitrides, for example. In some implementations, a multi-layer stack may include alternating layers of a silicon oxide (SiOₓ) and a titanium oxide (TiOₓ) in some implementations. The multi-layer stack may also include materials such as silicon nitrides (SiNₓ), silicon oxynitrides (SiOₓN_{y}), and niobium oxides (NbOₓ).

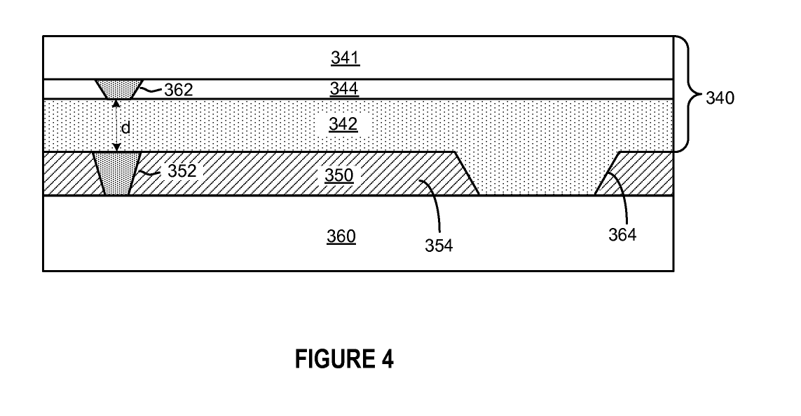

FIG. 4 shows a simplified cross-sectional view of an example of a metal circuit layer embedded in an optical dielectric layer. In the example of FIG. 4, circuit layers 350 and 340 are disposed on a backplane substrate 360. The circuit layer 350 includes a metal routing line 352 embedded in an optical dielectric material 354 as described above with respect to FIGS. 3A and 3B. The metal routing line 352 may be part of an M0 layer. The optical dielectric layer 354 may be a dark SOG material, for example, that is configured to absorb light to prevent the viewer from seeing reflective metal lines in the circuit layers 350 and 340. The circuit layer 340 includes a metal line 362, which may be part of an M1 layer, in a dielectric 344. The circuit layer 340 may also include additional circuitry 341, such as one or more additional metal layers (e.g., M2 and M3 layers) separated by dielectric layers. The metal routing line 352 and metal line 362 (and the M0 and M1 layers) are separated by a dielectric material 342. In some implementations, the dielectric material 342 is a transparent material, for example a transparent SOG material. Examples of transparent SOG materials include HSQ and methylsiloxane as well as other silicates and siloxanes. In the example of FIG. 4, the circuit layer 350 includes a display aperture 364. In some implementations, the dielectric material 342 is a low permittivity material to reduce parasitic coupling between the M0 layer and metal layers above it.

Routing lines, such as the metal routing line 352, can have parasitic capacitances and large signal induction with metal lines in other circuit layers. This can increase display power consumption and corrupt signal integrity. While thick dielectric layers that separate the various circuit layers can compensate for some of these deficiencies, such layers use more material, result in greater system thickness, and can be more susceptible to cracking and breaking and thus more difficult to process. In various implementations, the optical dielectric layer 354 is a material that provides beneficial optical properties apart from any electrical isolation properties. For example, a light absorbing material may be provided to the display apparatus to prevent a viewer from seeing the reflective metal circuitry in the circuit layers 340 and/or 350. By forming the metal routing line 352 in a trench in the optical dielectric layer 354, rather than on top of the optical dielectric layer 354, the distance d between the M0 and M1 layers may be increased and/or the thickness of dielectric needed to sufficiently separate the M0 and M1 layers be reduced. As a result, power and yield of the display device may be improved.

FIGS. 5A-5G shows examples of metal routing lines embedded in optical dielectric layers. Each of FIGS. 5A-5F shows a circuit layer 350 including a metal routing line 352 embedded in an optical dielectric material 354. As indicated above, an embedded metal routing line is a routing line having sidewalls at least partially abutting the optical dielectric layer. In the example of FIG. 5A, the entirety of sidewall 353 abuts the optical dielectric material 354. Although not depicted, in some implementations, a portion of the sidewalls of a metal routing line may be above or below the optical dielectric layer.

In some implementations, the bottom of the metal routing line 354 may be capped with an optical stack 370, as shown in the examples of FIGS. 5B, 5D and 5F. The term capped is used to denote an optical stack on or under the metal routing line 354 and does not imply an order of formation. In some implementations, the optical stack 370 may be formed prior to the metal routing line 354. The optical stack 370 may include one or more metal and/or dielectric layers. In one example, the optical stack 370 includes a dielectric/metal stack. Example metals include Mo, Ti, and W. Example total thicknesses of optical stacks may range from 50 nm to 300 nm. The optical stack 370 may be advantageous in implementations in which there is no optical dielectric layer thickness between the metal routing line 352 and the backplane substrate 360, as in FIG. 5B. In one example, the optical stack 370 blocks a viewer from seeing the reflective metal routing line 352. In implementations in which the surface area occupied by the metal routing lines embedded optical dielectric layer is relatively small, an optical stack 370 may be omitted as in the example of FIG. 5A.

In some implementations, a metal routing line 352 together with, if present, an optical stack 370 extends through the entire thickness of an optical dielectric layer 354. Examples are shown in FIGS. 5A and 5B: in FIG. 5A, the metal routing line 352 and the optical dielectric layer 354 have the same thickness, while in FIG. 5B, the optical dielectric layer 354 has the same thickness as the metal routing line 352 together with the optical stack 370.

In some implementations, a metal routing line 352 together with, if present, an optical stack 370 extends through only part of the thickness of an optical dielectric layer. Examples are shown in FIGS. 5C-5G. In such implementations, there may or may not be an etch stop in the optical dielectric layer 354. FIGS. 5C and 5D show examples of metal routing lines 352 extending through a partial thickness of optical dielectric layers 354 without etch stops. FIGS. 5E and 5F show examples of metal routing lines 352 extending through a partial thickness of optical dielectric layers 354 with etch stops 372. Example etch stop materials include silicon nitride (SiN) and silicon oxide (SiO₂).

In some implementations, an optical dielectric layer may be disposed under a TFT backplane. FIG. 5G shows an example of metal routing lines embedded in an optical dielectric layer disposed under a TFT backplane. In the example of FIG. 5G, metal routing lines 352 and optical stacks 370 are embedded in an optical dielectric layer 354 on a backplane substrate 360. An aperture 364 is formed in the optical dielectric layer 354. A TFT 365 is disposed on dielectric material 342 and connected to one of the metal routing lines 352 by an interconnect 366. The M0, M1 and M2 metal layers are indicated in FIG. 5G, with M0 layer including the metal routing lines 352, the M1 layer including a TFT gate 367, and the M2 layer including the TFT source and drain contacts 368.

As indicated above, the M0 layer including the metal routing lines 352 may be a low resistance layer. In some implementations, it can be used to route row and column lines within the display area, rather than on the periphery. In the example of FIG. 5G, one of the metal routing lines 352 is routed under the gate 367 of the TFT 365. In some implementations, the dielectric material 342 is transparent to visible light and has low permittivity to reduce capacitive coupling to the M1 and M2 metal layers.

In some implementations, an optical dielectric layer covers an embedded metal routing line such that the embedded metal routing line is separated from another metal layer at least in part by the optical dielectric layer. In FIG. 5G, for example, the optical dielectric layer 354 covers the metal routing lines 352 of the M0 layer such that they are separated from the M1 and M2 layers in part by the optical dielectric layer 354.

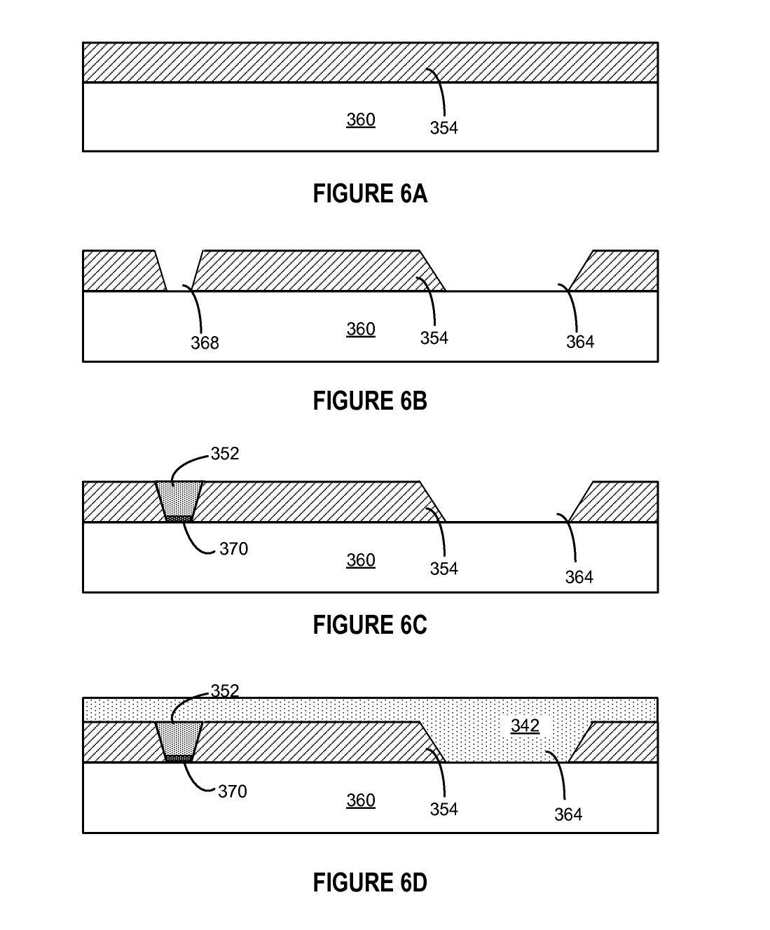

FIGS. 6A-8D show simplified cross-sectional views of various stages of examples of fabricating display apparatuses including metal routing lines embedded in optical dielectric layers. FIGS. 6A-6D show cross-sectional views of an example of fabricating an embedded metal routing layer as depicted in FIG. 5B. In FIG. 6A, an optical dielectric layer 354 is deposited on a backplane substrate 360. In some implementations, the backplane substrate 360 is a transparent substrate and can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex®, or other suitable glass material.

In some implementations, the optical dielectric layer 354 is a dark SOG layer formed by a spin-on deposition process. In a spin-on deposition process, a liquid solution containing a dielectric precursor in a solvent is dispensed on the backplane substrate 360. The dispensed solution can be subjected to one or more post-dispensation operations to remove the solvent and form the solid optical dielectric layer. In some implementations, the dielectric precursor is polymerized during a post-dispensation operation. The resulting optical dielectric layer can be an organic or inorganic dielectric layer according to the dielectric precursor used and the desired implementation.

Examples of dielectric precursors include doped or undoped silicates, siloxanes, and silsesquioxanes. As indicated above, in some implementations, the optical dielectric layer may be a carbon-doped dielectric layer to increase light absorption. In some implementations, a post-dispensation operation includes a thermal anneal at a temperature of between about 100° C. to 450° C. In some implementations, a single dispensation operation can performed to form the SOG layer. In some implementations, multiple dispensation/post-dispensation operation cycles can be performed to form the SOG layer. The SOG layer can be dispensed to a thickness greater than the desired thickness of the optical dielectric layer to accommodate shrinkage during anneal and subsequent planarization. Target thicknesses may range from about 0.5 microns to 3 microns in some implementations. Thickness may depend on the desired optical properties. For example, darker SOG materials may be thinner than lighter SOG materials, while still providing the desired absorptivity.

Depositing an optical dielectric layer may involve other methods instead of or in addition to spin-coating. These can include thermal or plasma-based chemical vapor deposition (CVD) or atomic layer deposition (ALD) processes or physical vapor deposition (PVD) processes. In implementations in which the optical dielectric layer is a multi-layer stack, deposition of the optical dielectric layer involves multiple processes.

In FIG. 6B, the optical dielectric layer 354 is etched to form a trench 368 that will accommodate a metal routing line. In the example of FIG. 6B, an aperture 364 is also etched in the same operation. In other implementations, the optical dielectric layer 354 does not include apertures. Etching may be a dry or wet etch according to the optical dielectric material. Example widths of a dry etch mask for the trench 368 can range from about 4 microns to 8 microns to obtain a metal routing line that is 3 microns to 7 microns wide. Example widths of a dry etch mask for the aperture 364 can range from about 10 microns to 20 microns, e.g., 13 microns to 18 microns. The lengths of the trench, metal routing line and aperture can be tens of microns, e.g., 30 microns to 100 microns, depending on the resolution of the display. Widths and lengths outside of these ranges may be appropriate for certain applications. For example, wider trenches may be appropriate to obtain wider M0 lines.

In FIG. 6C, a metal routing line 352 is formed in the trench 368. In the example of FIG. 6C, an optical stack 370 is formed prior to forming the metal routing line. Forming the optical stack can include one or more deposition techniques such as CVD, ALD, or PVD techniques. In some implementations, one or more metal layers of the optical stack 370 may be plated. Forming the metal routing line 352 may involve CVD, PVD, electroless plating, or electroplating. The metal routing line 352 may be etched to be planar with the optical dielectric layer 354 as depicted in FIG. 6C. The metal routing line 352 may also be etched such that it protrudes slightly above the optical dielectric layer 354.

Example thicknesses for the optical metal stack 370 may range from 50 nm to 300 nm. Example thicknesses for the metal routing line 352 may range from 0.3 microns to 3 microns, depending in part on the thickness of the optical dielectric layer 354.

In FIG. 6D, a dielectric material 342 is deposited to fill the aperture 364 and form an insulating layer to separate the metal routing line 352 from the next metal layer. In some implementations, the dielectric material 342 is a transparent material, for example a transparent SOG material. Example distances between metal layers range from about 0.2 micron to 4 microns. In subsequent operations, the remaining metal and dielectric circuit layers are formed.

In some implementations, an optical dielectric layer may be formed over one or more metal routing lines and optional optical stacks. This may be used, for example, to form optical dielectric layers that cover the metal routing lines. Referring to FIG. 5G, for example, the optical dielectric layer 354 may be deposited by a spin-coating process as described above after the metal routing lines 352 are formed on the backplane substrate 360.

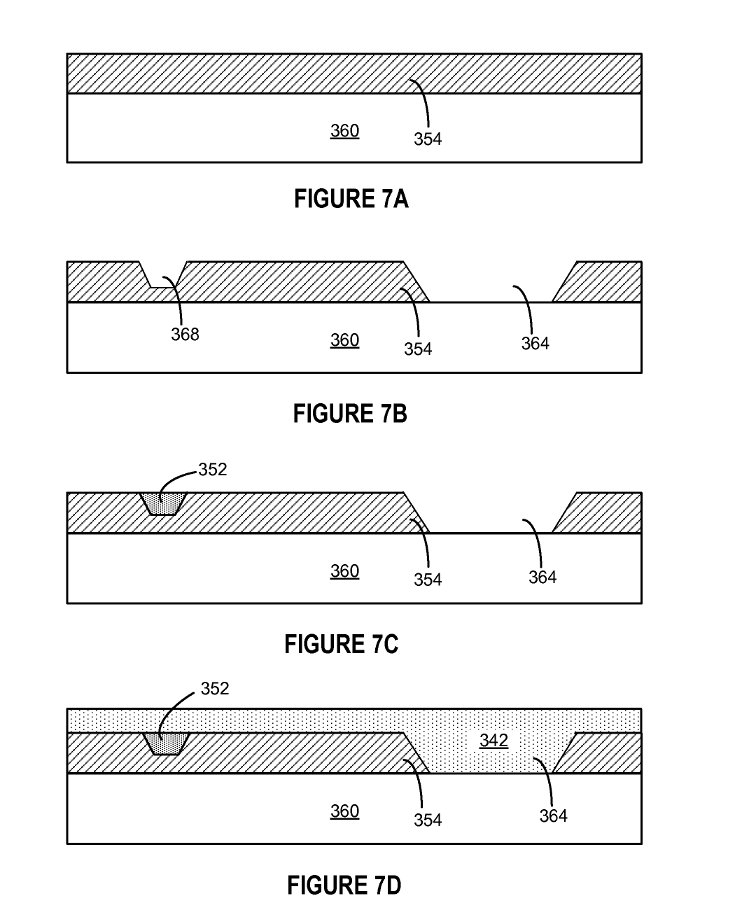

FIGS. 7A-7D show stages in an example of fabricating a metal routing line that extends only partway through an optical dielectric layer. Turning to FIG. 7A, an optical dielectric layer 354 is deposited on a backplane substrate 360 as described above with respect to FIG. 6A. In FIG. 7B, an aperture 364 is etched through the thickness of the optical dielectric layer 354. At the same time, a trench 368 that extends only partway through the optical dielectric layer 354 is etched. In some implementations, a gray scale mask may be used to appropriately slow the etch in the trench 368 relative to the etch in the aperture 364. In some other implementations, the sizes of the mask feature that produces trench 368 may be sufficiently small that the etch is sufficiently slowed relative to the etch of aperture 364. In an example, a 0.5 micron deep trench may be etched in a 1 micron thick optical dielectric layer. In another example, a trench having a depth between about 0.7 microns and 1 micron is etched in a 1.5 micron thick optical dielectric layer.

In FIG. 7C, a metal routing line 352 is formed in the trench 368. This operation may be performed as described above with respect to FIG. 6C. In FIG. 7C, the metal routing line 352 is formed in the trench without first depositing an optical stack. For example, a 0.5 micron metal routing line in a 1 micron thick optical dielectric layer allows 0.5 micron of optical dielectric material between the metal routing line and the backplane substrate, which may sufficiently block the reflective metal routing line from a viewer or provide other desired optical properties. However, in other implementations, an optical stack may be deposited.

In FIG. 7D, a dielectric material 342 is deposited to fill the aperture 364 and form an insulating layer to separate the metal routing line 352 from the next metal layer. This operation may be performed as described above with respect to FIG. 6D.

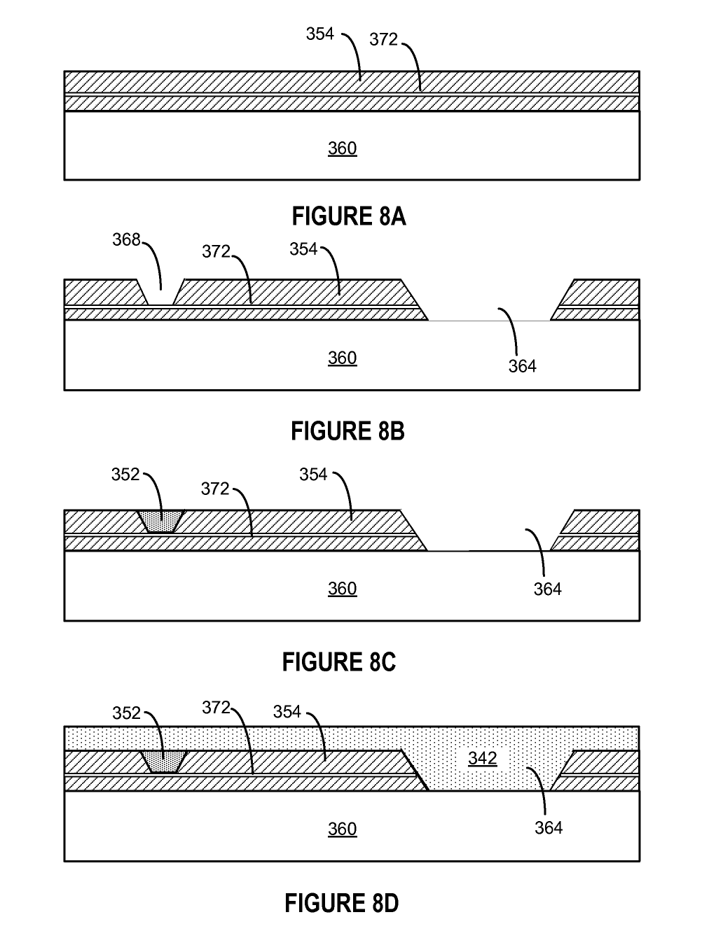

FIGS. 8A-8D show stages in an example of fabricating a metal routing line that extends only partway through an optical dielectric layer using an etch stop. In FIG. 8A, an optical dielectric layer 354 is deposited on a backplane substrate 360 in two stages with an etch stop 372 deposited between the stages. Any material that has etch selectivity to the dark SOG or other optical dielectric material may be used as an etch stop, with examples including SiN and SiO₂. The etch stop is formed at the desired depth of the metal routing line to be embedded in the optical dielectric layer 354.

In FIG. 8B, an aperture 364 is etched through the thickness of the optical dielectric layer 354, while a trench 368 that extends only to the etch stop 372 is etched. Etching the aperture 364 and the trench 368 involves two etch operations using different etch masks: one etch operation and mask to etch the aperture 364 and the trench 368 to the etch stop 372 and another etch operation and mask to break through the etch stop 372 and complete etch of the aperture 364. Use of the etch stop 372 can facilitate trench depth uniformity and repeatability.

In FIG. 8C, a metal routing line 352 is formed in the trench 368. This operation may be performed as described above with respect to FIGS. 6C and 7C. In FIG. 8D, a dielectric material 342 is deposited to fill the aperture 364 and form an insulating layer to separate the metal routing line 352 from the next metal layer. This operation may be performed as described above with respect to FIGS. 6D and 7D.

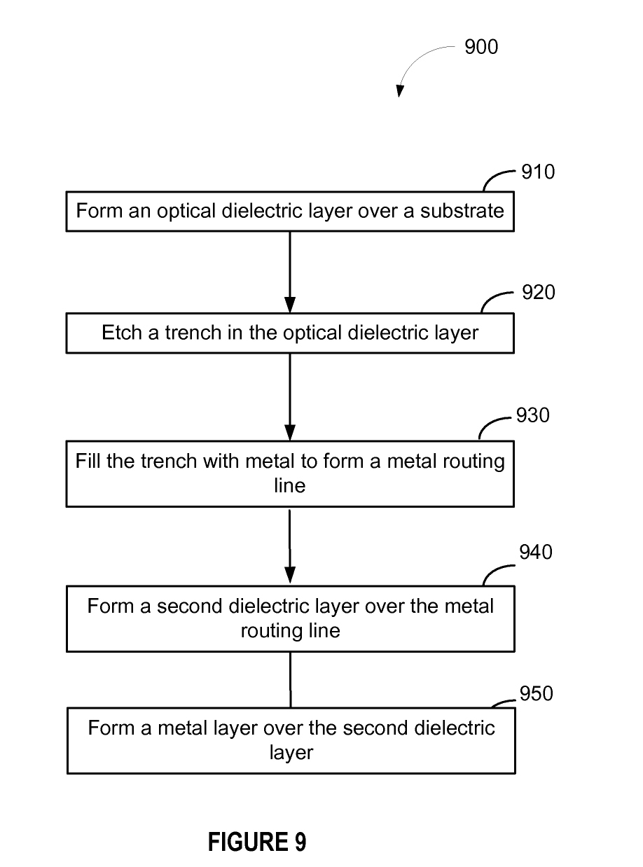

FIG. 9 is a flow diagram illustrating an example of operations of a method of fabricating an apparatus including a metal circuit layer embedded in an optical dielectric layer. The process 900 may be performed in different orders and/or with different, fewer or additional operations. At block 910, an optical dielectric layer is formed over a substrate. Examples of substrates are given above and can include transparent glass or plastic substrates. Non-transparent substrates may be appropriate for some devices. According to various implementations, the optical dielectric layer may be formed directly on the substrate or there may be on or more intervening layers between the substrate and the optical dielectric layer.

According to various implementations, the optical dielectric layer may be configured to reflect or absorb light from one or more sides of the optical dielectric layer. Any appropriate process, including a vapor deposition processes may be used. In some implementations, forming the optical dielectric layer can involve a spin-on deposition process, also referred to as a spin-coating process. In such a process, a liquid solution containing an optical dielectric precursor in a solvent is dispensed on the surface on which the optical dielectric layer is to be formed. The substrate may be rotated while or after the solution is dispensed to facilitate uniform distribution of the liquid solution during rotation by centrifugal forces. Rotation speeds of up to 6000 rpm may be used. In some implementations, for example for large panel processes, the liquid can be dispensed with an extrusion mechanism using a blade type nozzle, with no subsequent spinning.

The solvent may then be removed from the solid optical dielectric layer. In some implementations, the dielectric precursor is polymerized during a post-dispensation operation. The resulting optical dielectric layer can be an organic or inorganic dielectric layer according to the dielectric precursor used and the desired implementation.

Examples of dielectric precursors include doped or undoped silicates, siloxanes, and silsesquioxanes. Examples of solvents include water and alcohols such as ethanol or isoproponal, or combinations thereof. Liquid solutions may be fabricated or obtained commercially. The top surface of the dispensed liquid can be substantially planar.

As indicated above, in some implementations, the optical dielectric layer may be a carbon-doped dielectric layer to increase light absorption. In some implementations, a post-dispensation operation includes a thermal anneal at a temperature of between about 100° C. to 450° C. In some implementations, a single dispensation operation can performed to form the optical dielectric layer. In some implementations, multiple dispensation/post-dispensation operation cycles can be performed to form the optical dielectric layer. The layer can be dispensed to a thickness greater than the desired thickness of the optical dielectric layer to accommodate shrinkage during anneal and, if performed, subsequent planarization. Planarizing the optical dielectric layer can include one or more operations including lapping, grinding, chemical mechanical planarization (CMP), an anisotropic dry etch, or another appropriate method.

At block 920, a trench is etched in the optical dielectric layer. Block 920 may involve etching many trenches and/or a network of trenches to pattern the M0 or other metal circuit layer layout. In some implementations, block 920 may involve etching one or more apertures or other features in the optical dielectric layer. In some implementations, block 920 may involve a plasma-based etching process or a wet chemical etching process. As discussed above with reference to FIGS. 5A-5F, the trench may extend through the entire thickness of the optical dielectric layer or only through a portion of the thickness.

At block 930, the trench is filled with metal to form a metal routing line. In some implementations, the thickness of the metal routing line is at least 0.2 microns. Block 930 may involve one or more of CVD, PVD, electroless plating, or electroplating. The metal may be planarized by CMP, grinding, lapping or other appropriate planarization process. According to various implementations, the metal routing line may be planar with the optical dielectric layer or protrude above the optical dielectric layer. According to various implementations, a metal routing lines may include one or more layers of highly conductive metals such as Al, Cu, and Au and one or more layers of darker metal layers such as Mo, W, and Ti above and/or below the highly conductive metal.

At block 940, a second dielectric layer is formed over the metal routing line. In some implementations, forming the second dielectric layer can involve a spin-on deposition process. In some implementations, the second dielectric material is a transparent material, for example a transparent SOG material. Examples of transparent SOG materials include HSQ and methylsiloxane as well as other silicates and siloxanes. In some implementations, forming the second dielectric layer can involve a CVD process, such as a plasma enhanced CVD (PECVD) process. Examples of PECVD-deposited materials include silicon dioxide.

At block 950, a second metal layer is formed over the second dielectric layer. Block 950 may involve one or more of CVD, PVD, electroless plating, or electroplating. In some implementations, block 950 may involve forming the second metal layer directly on the second dielectric layer. In alternate implementations, the second metal layer may be partially embedded within the second dielectric layer or formed on one or more layers disposed between the second dielectric layer and the second metal layer.

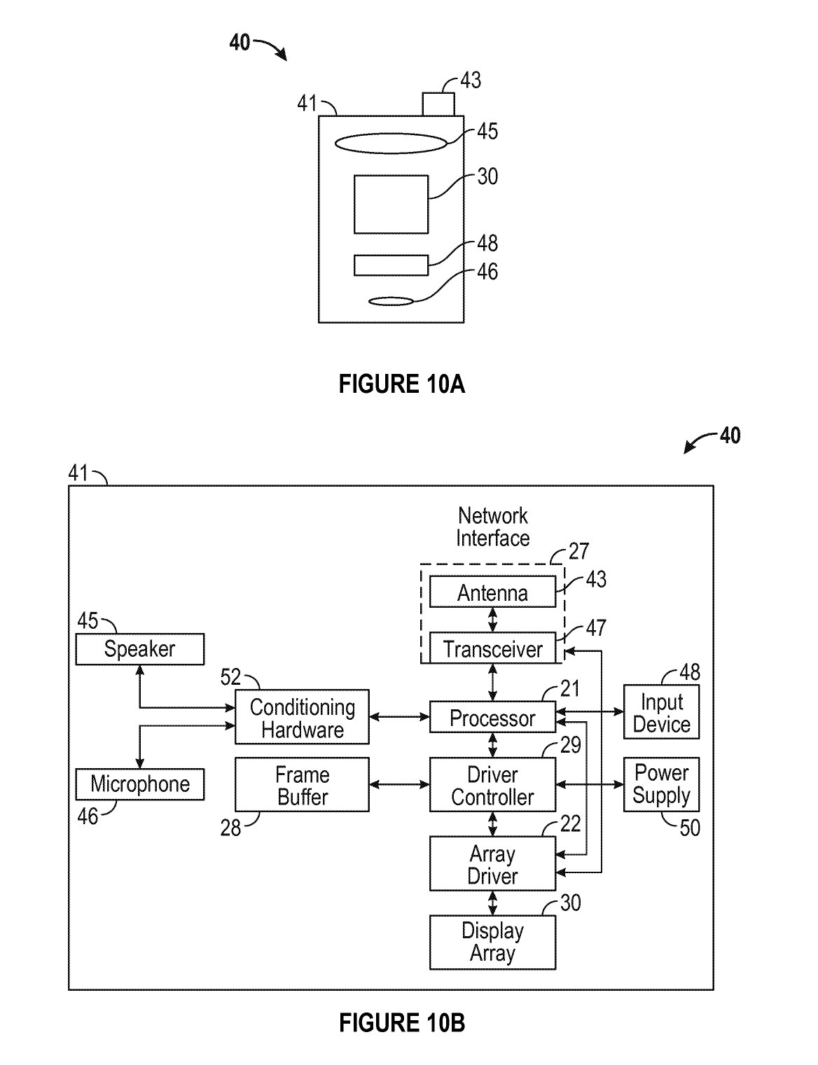

FIGS. 10A and 10B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower,” “front” and “behind,” “above” and “below” and “over” and “under,” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
a plurality of display elements;
an optical dielectric layer;
a first metal circuit layer capable of delivering electric signals to the display elements; and
a second metal circuit layer, wherein the second metal circuit layer is disposed between the plurality of display elements and the first metal circuit layer, and further wherein the first metal circuit layer is embedded in the optical dielectric layer.

2. The display apparatus of claim 1, wherein the optical dielectric layer is configured to absorb light.

3. The display apparatus of claim 1, wherein the optical dielectric layer is configured to reflect light.

4. The display apparatus of claim 1, wherein the optical dielectric layer includes a stack of dielectric layers configured to reflect light on one side of the stack and prevent transmission of light toward either side of the stack.

5. The display apparatus of claim 1, wherein the display elements are MEMS display elements.

6. The display apparatus of claim 1, wherein the optical dielectric layer is a spin-on-glass (SOG) layer.

7. The display apparatus of claim 1, wherein the optical dielectric layer is a carbon-doped SOG layer.

8. The display apparatus of claim 1, further comprising a third metal circuit layer disposed between the first metal circuit layer and the second metal circuit layer.

9. The display apparatus of claim 1, wherein the optical dielectric layer includes etched display apertures.

10. The display apparatus of claim 1, wherein the first metal circuit layer is embedded into only a portion of the thickness of the optical dielectric layer.

11. The display apparatus of claim 1, wherein the first metal circuit layer extends throughout the entire thickness of the optical dielectric layer.

12. The display apparatus of claim 1, further comprising an optical stack on or under the first metal circuit layer.

13. The display apparatus of claim 12, wherein the optical stack is embedded in the optical dielectric layer.

14. The display apparatus of claim 1, further comprising a second dielectric layer disposed between the first metal circuit layer and the second metal circuit layer, wherein the second dielectric layer is an optically transmissive SOG layer.

15. The display apparatus of claim 1, wherein the first metal circuit layer includes metal routing lines having a thickness of least 0.2 microns.

16. The display apparatus of claim 1, wherein the second metal circuit layer is configured to directly interact with the display elements.

17. The display apparatus of claim 1, wherein the second metal circuit layer includes a thin film transistor (TFT) gate.

18. The display apparatus of claim 1, further comprising a second dielectric layer disposed between the first metal circuit layer and a plurality of TFTs.

19. The display apparatus of claim 1, further comprising:
a processor capable of communicating with the display elements, the processor being capable of processing image data; and
a memory device capable of communicating with the processor.

20. The display apparatus of claim 19, further comprising:
a driver circuit capable of sending at least one signal to the display elements; and
a controller capable of sending at least a portion of the image data to the driver circuit.

21. The apparatus of claim 19, further comprising:
an image source module capable of sending the image data to the processor, wherein the image source module includes at least one of a receiver, transceiver and transmitter.

22. A display apparatus comprising:
a plurality of display elements;
means for delivering electric signals to the display elements, wherein the means for delivering electric signals to the display elements include a first metal circuit layer; and
means for electrically insulating the first metal circuit layer from a second metal circuit layer.

23. The display apparatus of claim 22, wherein the means for electrically insulating the first metal circuit layer from the second metal circuit layer include means for absorbing light from the second metal circuit layer.

24. The display apparatus of claim 22, wherein the means for electrically insulating the first metal circuit layer from the second metal circuit layer include means for absorbing light from the first metal circuit layer.

25. A method of fabricating a display device, comprising:
forming an optical dielectric layer over a substrate;
etching a trench in the optical dielectric layer;
filling the trench with metal to form a metal routing line having a thickness of at least 0.2 microns;
forming a second dielectric layer over the metal routing line; and
forming a metal layer over the second dielectric layer.

26. The method of claim 25, wherein the optical dielectric layer is configured to absorb light.

27. The method of claim 25, wherein the optical dielectric layer is configured to reflect light.

28. The method of claim 25, wherein the optical dielectric layer includes a stack of dielectric layers configured to reflect light on one side of the stack and prevent transmission of light toward either side of the stack.

29. The method of claim 25, wherein forming the optical dielectric layer includes a spin-coating process.
